(19) United States
(12) Patent Application Publication
(10) Pub. No.: US 2006/0217053 A1
(43) Pub. Date: Sep. 28, 2006

(54) Ventilated nail table

(76) Inventor: Rob Cardwell, Eugene, OR (US)

Correspondence Address: Rob Cardwell, P.O. Box 41780, Eugene, OR, 97404, US

(21) Appl. No.: 11/089,758

(22) Filed: Mar. 23, 2005

(51) Int. Cl. B08B 15/02

(52) U.S. Cl. 454/66

(57) ABSTRACT

A method of ventilating harmful airborne pollutants and odors, such as acetone and resins, from the immediate area during the acrylic or fiberglass nail process. Also removes debris from becoming airborne breathable particulates, such as nail dust. A column which is integral to the process of eliminating said pollutants can be used with ducting, as ducting itself and doubles as a product display. The column's design is for ease of placement, not limited to being close to a wall in order to hide ducting.

### BACKGROUND OF THE INVENTION

The invention related to manicure tables, more particularly, the removal of harmful airborne pollutants and odors from the immediate area during the artificial nail process to include nail dust from filing.

The manicure table is equipped with a center section that is hollow and has grating over a hole to allow ventilation/vacuuming of the immediate area through the hollow section to a section with ducting attached by coupling and the ducting continues through the cabinet or other section of the table to a tower and continues up through the tower to the ceiling and to a ventilation/vacuum system in the attic or other appropriate section of a building and then is vented to the outdoors.

### BRIEF DESCRIPTION OF THE DRAWING

FIG. 1 is a view of the manicure table from the nail technician's side of the table.

FIG. 2 is a cabinet with drawers and is necessary to close off one side of the hollow section to allow ventilation/vacuum system to pull air from the hollow section in order to eliminate harmful chemicals, etc. and is necessary to complete the table and for stability.

FIG. 3 is a hollow section called the deck or bridge with a hole covered by grating.

FIG. 4 is a cabinet with a single coupler (not shown) attached to the upper left or right inside section that meets up with the deck or bridge where hole is visible, see FIG. 3. In the far corner on the top of the cabinet is a hole (larger of the five) in which the ducting is routed.

FIG. 5 is the column or tower which slides up to and is attached to the cabinet. The ducting used in venting the table runs from the top of the column or tower where it is attached to the lower side of a two sided coupler, and is strung down through the tower to the hole in the cabinet, FIG. 3 and is then attached to the coupler in the upper portion of the cabinet, FIG. 3 to the coupler which couples the hollow section of FIG. 2. From the top of the tower the ducting is attached to the upper side of the coupler to the attic where a ventilation/vacuum system would be housed and from the ventilation/vacuum system the ducting is vented to the outdoors. The tower also doubles as a product display when shelving is attached.

FIG. 5 may also house a ventilation/vacuum system and the coupler in FIG. 3 with ducting attached can be attached to the ventilation/vacuum system in the cabinet and then ducted out through the column into the attic and on to the outdoors.

FIG. 6 is a sleeve which rises to the ceiling for aesthetics to cover the ducting which extends to the ceiling from a two sided coupler attached to the column top.

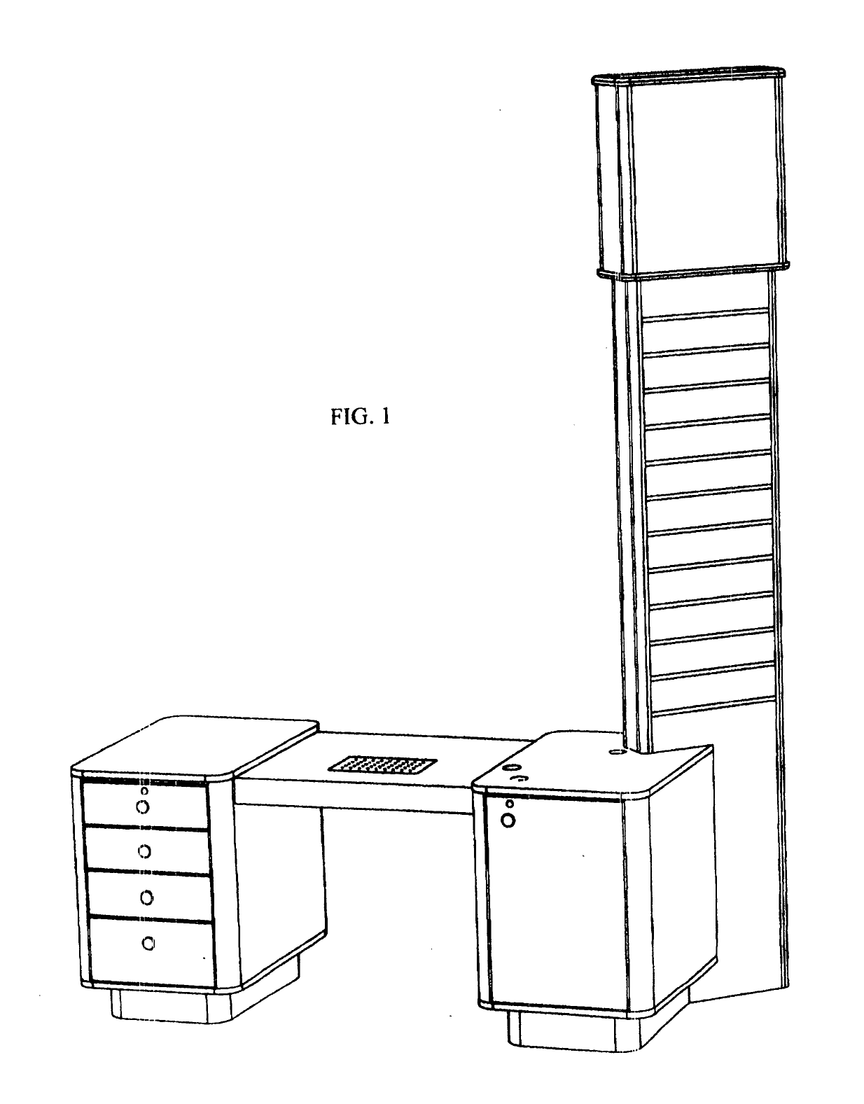

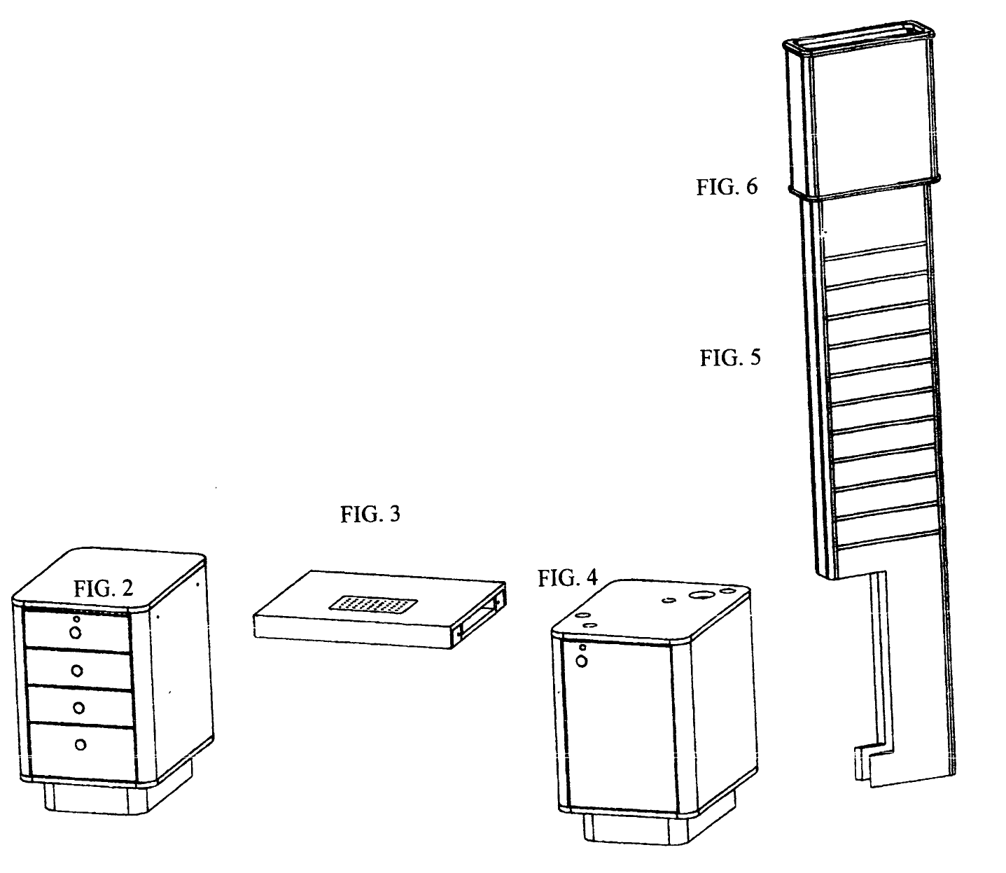

What I claim as my invention:

1. A method of evacuating harmful airborne pollutants and odors during the nail manicure process, such as but not limited to acetone and resins, herein known as artificial nail products, from the area above the deck or bridge of a manicure table through the perforated grid on top of the deck or bridge. A cabinet to one side of the deck or bridge, which the deck or bridge is attached, with a coupler in the cabinet attached to ducting that continues through a column or tower in which the ducting continues to the ceiling and into the attic or other acceptable place to a ventilation/vacuum system which evacuates the contaminants to the outdoors to insure a continuous evacuation of air during the manicure process. Other acceptable place for a ventilation/vacuum system as suggested above would be housed in the cabinet where the column is attached and ducting would continue through the column to the attic and on to the outdoors.

2. A column or tower in which ducting may be used to carry harmful airborne pollutants and odors from the deck or bridge through the cabinet or, said column may be used as the ducting itself and with sleeve extension said column would accommodated different height ceilings, column also doubles as a display for product when shelving is attached and said column is built with sections for shelving to be attached.
